(19) United States
(12) Patent Application Publication
(10) Pub. No.: US 2007/0005625 A1
(43) Pub. Date: Jan. 4, 2007

(54) Storage architecture for embedded systems

(75) Inventors: Haris Lekatsas, Princeton, NJ (US); Srimat T. Chakradhar, Manalapan, NJ (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 11/231,738

(22) Filed: Sep. 21, 2005

Related U.S. Application Data
(60) Provisional application No. 60/696,398, filed on Jul. 1, 2005.

(51) Int. Cl. G06F 7/00

(52) U.S. Cl. 707/101

(57) ABSTRACT

A storage management architecture is disclosed which is particularly advantageous for devices such as embedded systems. The architecture provides a framework for a compression/decompression system which advantageously is software-based and which facilitates the compression of both instruction code and writeable data.

### BACKGROUND OF THE INVENTION

The present invention is related to storage architectures and, more particularly, to architectures for handling instruction code and data in embedded systems.

Embedded systems pose serious design constraints, especially with regards to size and power consumption. It is known that storage such as memories can account for a large portion of an embedded system's power consumption. It would be advantageous to incorporate transformations such as compression and encryption in embedded systems in a manner that can reduce the size of the storage while maintaining acceptable performance.

Compression techniques are well-known. Previous work on incorporating compression in embedded systems, in general, has focused on hardware solutions that compress the instruction segment only. See, e.g., L. Benini et al., “Selective Instruction Compression for Memory Energy Reduction in Embedded Systems,” IEEE/ACM Proc. of International Symposium on Lower Power Electronics and Design (ISLPED '99), pages 206-11 (1999). Software-based approaches to compression are appealing due to the reduction in hardware complexity and the greater flexibility in the choice of compression algorithm. It has been proposed to use a software-based approach to decompress instruction code on embedded systems with a cache. See C. Lefurgy and T. Mudge, “Fast Software-Managed Code Decompression,” presented at CASES (Compiler and Architecture Support for Embedded Systems) '99 (October 1999). A compressed filesystem called CRAMFS has been implemented for the Linux/GNU operating system which allows read-only code and data to be compressed for embedded system applications. See CRAMFS, http://sourceforge.net/projects/cramfs (February 2002). The focus on read-only data has advantages: read-only data does not change during execution, thereby allowing compression before execution and the decompression of small portions at runtime. Indexing read-only data, i.e. locating the data in a compressed stream is substantially easier than in the case where runtime compression is required.

For many embedded systems applications, it would be preferable to compress all data areas including writeable data. Often executables contain large data areas such as a .bss area that corresponds to uninitialized data, which can be modified during runtime. Or worse, the executable can have a large dynamically-allocated data area. When these areas are large and not compressed, they can result in a significant reduction of the benefits of read-only data compression.

### SUMMARY OF INVENTION

A storage management architecture is disclosed which is particularly advantageous for devices such as embedded systems. The architecture includes a transformation engine, preferably implemented in software, which transforms data into a transformed form, e.g., the transformation engine can be a compression/decompression engine, which compresses data into a compressed form, and/or the transformation engine can be an encryption/decryption engine which encrypts data into an encrypted form. As a program is executed on a processor of a device, portions of the program and the program's data are stored in an untransformed storage area of the device. As storage resources are depleted during execution of the program, the transformation engine is utilized to transform (e.g., compress) at least one portion of the program or data in the untransformed storage area into a transformed form, which can be moved into a transformed storage area allocated for transformed portions of the program or data. Storage resources in the untransformed storage area of the device can be dynamically freed up. This transformed storage area can be enlarged or reduced in size, depending on the needs of the system, e.g., where a compressed portion to be migrated to a compressed storage area does not fit within the currently allocated space for the area, the system can automatically enlarge the compressed storage area. The transformed storage area can include a storage allocation mechanism, which advantageously allows random access to the transformed portions of the program. The disclosed architecture, accordingly, provides a framework for a compression/decompression system which advantageously can be software-based and which facilitates the compression of both instruction code and writeable data.

The architecture allows different portions of the program (e.g., instruction code segments and data segments and even different types of data) to be treated differently by the storage management structure, including using different transformation techniques on different portions of the program. Read-only portions of a program, such as instruction code, can be dropped from the untransformed storage area without compression and read back as needed. By facilitating the transformation/compression of both instruction code and data residing in storage, the system can provide savings on storage overhead while maintaining low performance degradation due to compression/decompression. The disclosed transformation framework advantageously does not require specialized hardware or even a hardware cache to support compression/decompression. The disclosed framework can be readily implemented in either a diskless or a disk-based embedded system, and advantageously can handle dynamically-allocated as well as statically-initialized data.

These and other advantages of the invention will be apparent to those of ordinary skill in the art by reference to the following detailed description and the accompanying drawings.

### BRIEF DESCRIPTION OF DRAWINGS

FIG. 1 depicts a system architecture, in accordance with an embodiment of an aspect of the invention.

FIG. 2 is a flowchart of processing performed by the system depicted in FIG. 1 as data is moved to a transformed storage area.

FIG. 3 depicts an abstract diagram of the usage of a mapping table to allocate storage in a transformed storage area.

### DETAILED DESCRIPTION

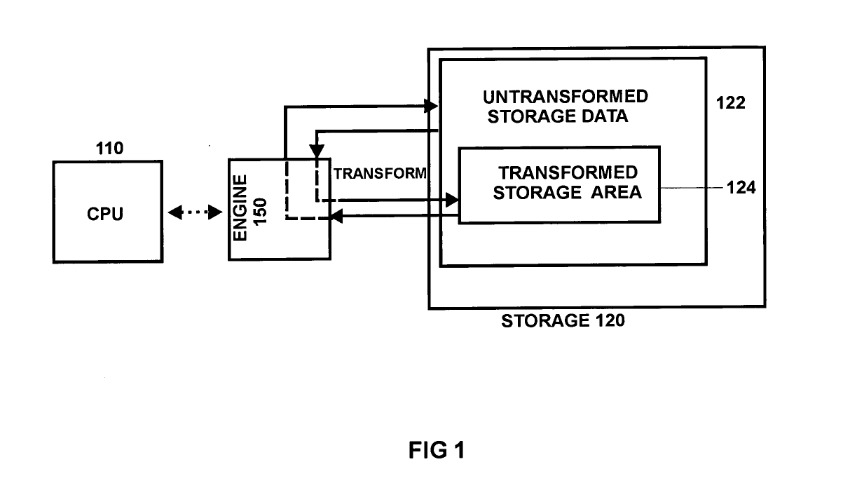

FIG. 1 is an abstract diagram of an illustrative embedded system architecture, arranged in accordance with a preferred embodiment of the invention. The embedded system includes a processor 110 and storage 120. The processor 110 and storage 120 are not limited to any specific hardware design but can be implemented using any hardware typically used in computing systems. For example, the storage device 120 can be implemented, without limitation, with memories, flash devices, or disk-based storage devices such as hard disks.

The system includes a transformation engine 150, the operation of which is further discussed below. The transformation engine 150 is preferably implemented as software. The transformation engine 150 serves to automatically transform data (and instruction code, as further discussed below) between a transformed state and an untransformed state as the data is moved between different areas of storage. For example, and without limitation, the transformation engine 150 can be implemented as a compression/decompression engine where the transformed state is a compressed state and where the untransformed state is an uncompressed state. As another example, the transformation engine 150 can be implemented as an encryption/decryption engine where the transformed state is an encrypted state and where the untransformed state is a decrypted state. The present invention is not limited to any specific transformation technique including any specific compression or encryption algorithm.

The arrangement of the different storage areas and their roles in the system architecture are discussed below, without limitation, in the specific context of the example transformation of compression.

As depicted in FIG. 1, an area of the storage 120 is allocated to an uncompressed area 122. The uncompressed area 122 is accessible to the processor 110 and is used by the processor 110 to store uncompressed instruction code and data during the execution of a program. The present invention is not limited to any specific storage allocation technique with regards to the uncompressed area 122, and any convenient conventional techniques can be utilized. When a program is executed by the processor 110, more and more of the area 122 will be utilized by the program. In an embedded system with limited storage resources, the uncompressed area 122 can be quickly depleted of storage resources. Accordingly, it would be advantageous to dynamically compress portions of the program stored in the uncompressed area 122 during execution of the program.

Instruction segments do not typically change during runtime, with the notable exception of self-modifying code, which is rarely used today. This means that it is possible to compress instruction code once offline (before execution) and store the code in a filesystem in a compressed format. During runtime, only decompression is required. For such systems, a read-only approach to handling the code suffices. Data areas, on the other hand, require a different strategy. Data changes dynamically during execution, and, accordingly, online compression is necessary. Data can include statically-initialized data (e.g., .bss areas) and dynamically-allocated data. Statically-initialized data occupies a fixed amount of space, which is often very compressible initially as it is typically filled with zeroes upon application initialization. Dynamically-allocated data, on the other hand, occupies variable amounts of space and is sometimes avoided in embedded systems as it can require more storage than what is actually available to the system. Both statically-initialized data and dynamically-initialized data require online compression techniques, as they both can be written. The inventors have observed that both statically-initialized and dynamically-allocated data areas tend to be highly compressible, due to the large areas of contiguous zeroes which compress very well.

It should be noted that the disclosed framework advantageously can handle both statically-initialized data and dynamically-allocated data.

As more and more of the uncompressed area 122 is depleted during the execution of the program, as further described below, the system is configured to dynamically compress selected portions of the data stored in the uncompressed area 122 and, thereby, free up additional space in the uncompressed area 122. In order to maintain random access to the compressed data, the system preferably allocates a compressed storage area 124 for the compressed data which is configured to permit the system to retrieve the compressed data later when needed by the processor 110. The compressed storage area 124 is preferably arranged in accordance with the storage allocation technique described in co-pending commonly-assigned Utility patent application Ser. No. 10/869,985, entitled “MEMORY COMPRESSION ARCHITECTURE FOR EMBEDDED SYSTEMS,” Attorney Docket No. 03041, filed on Jun. 16, 2004, the contents of which are incorporated by reference, although it should be noted that other storage allocation techniques can be utilized as long as they provide random access to the compressed data. It should also be noted that although FIG. 1 depicts the compressed storage area 124 and the uncompressed area 122 as being contiguous, there is no requirement that the two be contiguous. As further described below, the compressed storage area 124 can represent many noncontiguous parts of the storage spread across the uncompressed area 122 and can grow from some minimal size and shrink as the system needs change during execution of the program.

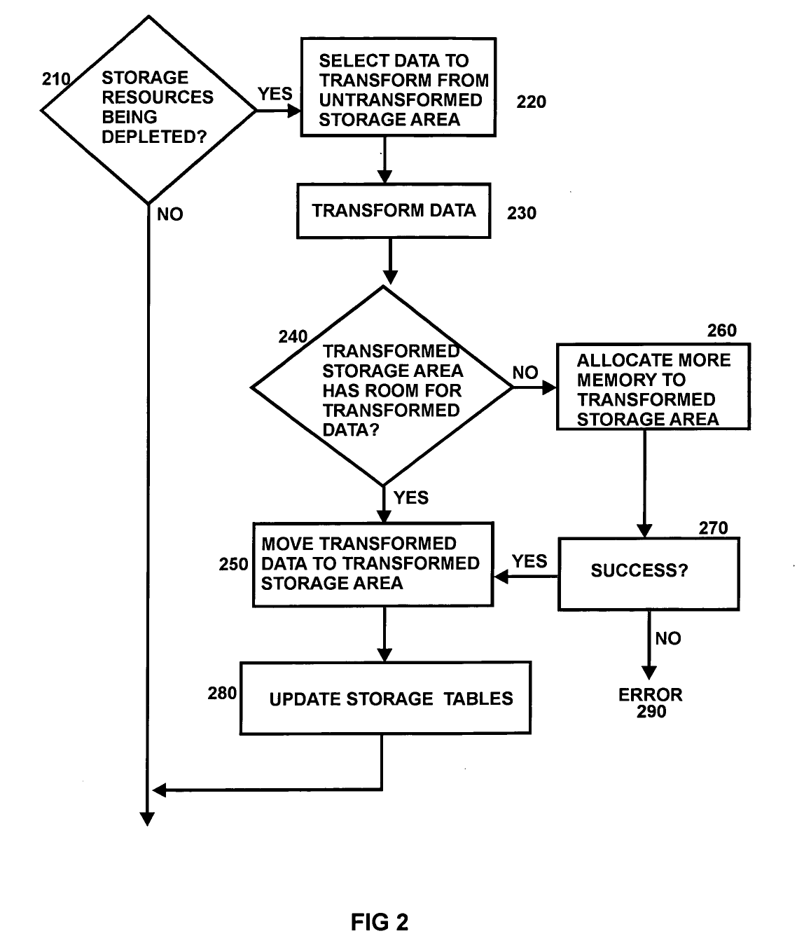

FIG. 2 is a flowchart of processing performed by the system depicted in FIG. 1 as the uncompressed area becomes depleted during execution of the program. At step 210, the system determines that uncompressed resources are low, e.g., by determining that the amount of free storage resources in the uncompressed area has dropped below some threshold or when a storage request cannot be satisfied. At step 220, the system selects data in the uncompressed area to compress. The system can make the selection based on the type of data being stored, how compressible the data is, how often the data is used by the processor, etc. The system can use known techniques for selecting such data, such techniques being typically used to extend physical memory and provide virtual memory using a disk as extra memory space. After selecting the data to be compressed, the system transforms the data at step 230 using the transformation engine, e.g., compresses the data using an advantageous fast compression algorithm. At step 240, the system tries to allocate room for the compressed data in the existing free storage resources of the compressed storage area. If the compressed storage area has existing free storage resources to allocate to the compressed data, then the compressed data is moved into the compressed storage area at step 250. The data structures maintaining the allocation of storage in the compressed storage area and the uncompressed area are updated at step 280. If the compressed storage area does not have enough existing free storage resources to allocate to the compressed data, then the system attempts to allocate more storage to the compressed storage area, thereby expanding the size of the compressed storage area. This may result in a decrease in the overall storage available to the uncompressed area, as further discussed below; presumably, however, more of the uncompressed area can be freed up by moving large compressible data from the uncompressed area to the compressed storage area. If the system is successful in allocating more storage for the compressed storage area at step 260, then the system proceeds to move the compressed data into the compressed storage area at step 250. If not, then the system can report an error at step 290.

Alternatively, the system can implement a compressed storage hierarchy in which data which cannot be allocated to this compressed storage area is moved to a next compressed storage area or a compressed area in the filesystem.

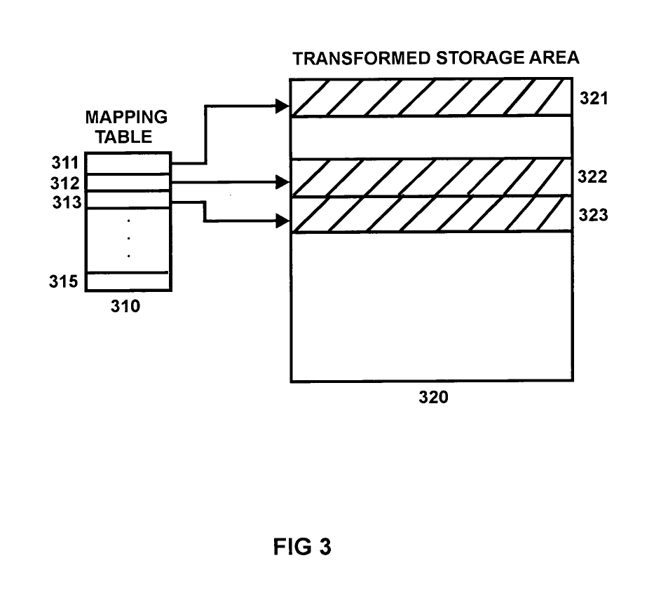

As data is migrated from the uncompressed area 122 to the compressed storage area 124, the system must keep track of what data has been moved and how to retrieve the data. As mentioned above, any advantageous memory allocation technique can be utilized, although it is particularly advantageous to utilize a mapping table to track the compressed data in the compressed storage area, as illustrated by FIG. 3. Note that although the compressed storage area 320 depicted in FIG. 3 is represented as being virtually contiguous, the compressed storage area 320 is actually allocated memory address ranges in the storage, which may or may not be contiguous. Accordingly, and as noted above, areas 122 and 124 can in fact be one area with compressed and uncompressed portions mixed together in a non-contiguous fashion. As shown in FIG. 3, data is preferably compressed in blocks. The mapping table 310 stores an entry 311, 312, 313, . . . 315 for each compressed block. Each entry is a pointer to the storage location of the compressed blocks 321, 322, . . . 323 in the compressed storage area. Thus, if a request is received for a compressed block within a data segment, e.g., compressed block 322 in FIG. 3, then the system need only find the mapping table entry for compressed block 322, namely entry 312, which holds the pointer to the location of the compressed block. Free space in the compressed storage area 320 can be represented by a linked list of storage locations of free space. When the system needs to allocate space in the compressed storage area 320 for new compressed data, the system can consult the linked list. As compressed data is accessed from the compressed storage area 320, it can be migrated back into the uncompressed area and its space freed up and added to the linked list of free storage locations.

As alluded to above, the compressed storage area 124 can be reserved for certain portions of a program, including without any limitation data segments or certain types of data segments. The introduction of the compressed storage area may result in an increased number of page transfer requests because the working space storage is now smaller (part of it being allocated to the compressed storage area), and it may not be sufficient for running all processes. Moving the data in and out will also result in latency, including the time for storage access as well as the time for the decompression and compression. The system, however, is now capable of allowing processes to run even if the total physical storage would not normally be sufficient; the compressed storage area is effectively providing more addressable storage space.

Read-only portions of the program (such as instruction code) can be discarded from the uncompressed area 122 and read back by the system as necessary from wherever the system stores its initial program and files. It is also possible to store read-only portions of the program in pre-allocated parts of compressed area 124. The present invention is not limited to any particular architecture for storing the program files necessary to operate the device.

It should be noted that the storage management techniques illustrated above can be readily implemented in many different ways. The technique can be incorporated into the memory management code or related code in the device's operating system. Alternatively, the technique can be incorporated directly into the application being executed on the processor.

Again, it should be noted that the present invention is not limited to any specific transformation or any specific compression algorithm. By selecting a number of bytes in storage to be compressed individually that is sufficiently large (preferably 1 KB or higher), the inventors have found that many general-purpose compression algorithms have good compression performance. In terms of compression/decompression speed, the inventors have found that the best performing algorithms tend to be dictionary-based algorithms, designed to use small amounts of storage during compression and decompression. The above architecture is designed in such a way that it is readily possible to “plug-in” any advantageous compression algorithm. It should also be noted that the compression algorithm used to compress the code can be different than the compression algorithm used to compress the data or different types of data. Thus, when implementing the framework, one can take advantage of the fact that the instruction code need not be compressed and use an algorithm for the instruction code that compresses slowly but decompresses quickly.

The present invention is also not limited to a single form of transformation. The transformation engine described above can perform multiple transformations on the selected data portion, e.g., the engine can perform compression on the selected portion and then perform encryption on the compressed data. Alternatively, the engine can selectively perform encryption and compression on only sensitive data blocks in the compressed storage area while performing compression on other types of data residing in the compressed storage area.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents. As but one of many variations, it should be understood that transformations other than compression can be readily utilized in the context of the present invention. Moreover, although the present invention has been described with particular relevance to embedded systems, the principles underlying the present invention are applicable beyond embedded systems to computing devices in general.

What is claimed is:

1. A software-implemented method of storage management in a device comprising a processor and storage, the method comprising the steps of:
storing portions of a computer program and its data in an uncompressed storage area for use by the processor during execution of the computer program; and
as storage resources are depleted during execution of the computer program, compressing at least one portion of the computer program or data in the uncompressed storage area and moving it into a compressed storage area, thereby freeing up resources in the uncompressed storage area.

2. The method of claim 1 wherein the compressed storage area is enlarged if the compressed portion does not fit within currently allocated space for the area.

3. The method of claim 1 wherein the compressed storage area is reduced in size if compression is unneeded.

4. The method of claim 1 wherein the compressed portion is a data portion of the computer program.

5. The method of claim 4 wherein the compressed portion is a data portion of the computer program holding data of a particular type that is more readily compressed than other portions of the computer program.

6. The method of claim 1 wherein the compressed portion is compressed using a dictionary-based compression algorithm.

7. The method of claim 1 wherein the compressed portion is encrypted after compression.

8. The method of claim 1 wherein a mapping table is used to track locations of the compressed portion within the compressed storage area.

9. The method of claim 1 wherein the device is an embedded device.

10. A device comprising:
a processor;
storage;
a transformation engine; and
a storage management module which stores portions of a program and its data in an untransformed storage area for use by the processor, uses the transformation engine to transform at least one portion of the program or data stored in the untransformed storage area, and which moves the transformed portion from the untransformed storage area into a transformed storage area allocated for transformed portions of the program or data.

11. The device of claim 9 wherein the transformation engine is an encryption/decryption engine.

12. The device of claim 9 wherein the transformation engine is a compression/decompression engine.

13. The device of claim 9 wherein the transformation engine is a combined compression/decompression and encryption/decryption engine, where the transformation engine performs compression before encryption.

14. The device of claim 9 wherein the storage management module has access to a mapping table which is used to track locations of the transformed portions within the transformed storage area.

15. The device of claim 9 wherein the device is an embedded device.

16. The device of claim 9 wherein the transformation engine and the storage management module are implemented in software.

17. A storage management arrangement for a device comprising a processor and storage, the arrangement comprising:
means for storing portions of a computer program and its data in an untransformed storage area for use by the processor during execution of the computer program; and
means for transforming, as storage resources are depleted during execution of the computer program, at least one portion of the computer program or data in the untransformed storage area and moving the transformed portion into a transformed storage area, thereby freeing up resources in the untransformed storage area.

18. The storage management arrangement of claim 17 wherein the portion is transformed by applying a compression algorithm to the portion.

19. The storage management arrangement of claim 17 wherein the portion is transformed by applying an encryption algorithm to the portion.

20. The storage management arrangement of claim 17 wherein the device is an embedded device.
